(19) United States
(12) Patent Application Publication
(10) Pub. No.: US 2017/0270700 A1
(43) Pub. Date: Sep. 21, 2017

(54) DISPLAY DEVICE, METHOD OF CONTROLLING DISPLAY DEVICE, AND PROGRAM

(71) Applicant: SEIKO EPSON CORPORATION, Tokyo (JP)

(72) Inventor: Takahiro ANO, Matsumoto-Shi (JP)

(73) Assignee: SEIKO EPSON CORPORATION, Tokyo (JP)

(21) Appl. No.: 15/452,018

(22) Filed: Mar. 7, 2017

(30) Foreign Application Priority Data
Mar. 17, 2016 (JP) 2016-053451

(51) Int. Cl. G06T 11/60; G06F 3/0488; H04N 9/31; G06F 3/0354

(52) U.S. Cl. CPC G06T 11/60; G06F 3/03545; G06F 3/04883; H04N 9/3179

(57) ABSTRACT

A projector includes a display section adapted to display an image on a display surface, a position identification section adapted to identify a position of a pointing element to the display surface, a drawing section adapted to generate a drawn image based on the position identified by the position identification section, a superimposition section adapted to superimpose the drawn image on an external device image based on a video signal supplied from an external device to generate the image, and a processing section adapted to detect a change in a monitoring area set in advance of generation of the drawn image in a display area of an image to be displayed by the display section, and adapted to erase the drawn image having been superimposed on an image having been displayed before the change in a case in which the monitoring area changes.

### BACKGROUND

### 1. Technical Field

The present invention relates to a display device, a method for controlling a display device, and a program.

### 2. Related Art

As an invention of using a pointing element as a pointing device, there can be cited a projector disclosed in, for example, JP-A-2013-247486. The projector is provided with an imaging element, and shoots the pointing element using the imaging element. Further, the projector identifies the coordinate of the pointing element in a projection area from the picture obtained by the shooting, and then performs a drawing process based on the coordinate thus identified. Further, some projectors are provided with a function of treating the pointing element in substantially the same manner as the mouse to operate the PC using the pointing element in the case of projecting an image of a personal computer (PC).

In the case of performing drawing with the pointing element when projecting the image of the PC, a line drawn in accordance with the movement of the pointing element is what is generated and then projected by the projector. Therefore, in the case in which the PC is operated, and the picture to be projected is changed, the line drawn in the image before the change remains, and becomes an incoherent line for the picture after the change.

### SUMMARY

An advantage of some aspects of the invention is to provide a technology of erasing a drawing not corresponding to an image in the case in which the drawing has been performed using a pointing element on the image displayed and then the image to be displayed has been changed.

An aspect of the invention provides a display device including a display section adapted to display an image on a display surface, a position identification section adapted to identify a position of a pointing element to the display surface, a drawing section adapted to generate a drawn image based on the position identified by the position identification section, a superimposition section adapted to superimpose the drawn image on an external device image based on a video signal supplied from an external device to generate the image, and a processing section adapted to detect a change in a monitoring area set in advance of generation of the drawn image in a display area of the image to be displayed by the display section, and adapted to erase the drawn image having been superimposed on an image having been displayed before the change in a case in which the monitoring area changes.

According to this aspect of the invention, in the case in which the drawing has been performed using a pointing object on the image displayed, when the image to be displayed is changed, it is possible to erase the drawing not corresponding to the image having changed.

The aspect of the invention may be configured such that the display device further include a storage section adapted to store an image displayed in the monitoring area, and the drawn image generated by the drawing section while the image is displayed so as to be associated with each other, and the processing section supplies the superimposition section with the drawn image stored so as to be associated with the image displayed in the monitoring area.

According to this configuration, when the image displayed by the display section changes, it is possible to restore and display the drawn image corresponding to the image having changed.

The aspect of the invention may be configured such that the monitoring area is an area designated by an operation of the pointing element.

According to this configuration, it is possible to set the monitoring area in accordance with the image currently displayed.

The aspect of the invention may be configured such that a number of the monitoring areas is plural.

According to this configuration, the change of the image to be displayed by the display section can more correctly be detected.

The aspect of the invention may be configured such that the monitoring areas are areas extending in at least one predetermined direction in the image to be displayed on the display surface.

According to this configuration, the change of the image to be displayed by the display section can more correctly be detected.

The aspect of the invention may be configured such that a number of the directions is plural.

According to this configuration, the change of the image to be displayed by the display section can more correctly be detected.

The aspect of the invention may be configured such that the processing section detects a change of the external device image in the monitoring area.

According to this configuration, in the case in which the drawing has been performed using a pointing object on the image supplied from the external device, when the image to be displayed is changed, it is possible to erase the drawing not corresponding to the image having changed.

The aspect of the invention may be configured such that the display device further includes an imaging section adapted to take the image displayed by the display section, and output a taken image obtained by imaging, and the processing section detects a change of a part corresponding to the monitoring area in the taken image.

According to this configuration, the change of the image in the monitoring area is detected by imaging, and if the image to be displayed is changes, it is possible to erase the drawing not corresponding to the image having changed.

Another aspect of the invention provides a method of controlling a display device including a display section adapted to display an image on a display surface, the method including the steps of identifying a position of a pointing element to the display surface, generating a drawn image based on the position identified in the step of identifying the position of the pointing element, superimposing the drawn image on an external device image based on a video signal supplied from an external device to generate the image, and detecting a change in a monitoring area set in advance of generation of the drawn image in a display area of the image to be displayed by the display section, and erasing the drawn image having been superimposed on an image having been displayed before the change in a case in which the monitoring area changes.

According to this aspect of the invention, in the case in which the drawing has been performed using a pointing object on the image displayed, when the image to be displayed is changed, it is possible to erase the drawing not corresponding to the image having changed.

Another aspect of the invention provides a computer program adapted to make a computer of a display device including a display section adapted to display an image on a display surface execute a process including the steps of identifying a position of a pointing element to the display surface, generating a drawn image based on the position identified in the step of identifying the position of the pointing element, superimposing the drawn image on an external device image based on a video signal supplied from an external device to generate the image, and detecting a change in a monitoring area set in advance of generation of the drawn image in a display area of the image to be displayed by the display section, and erasing the drawn image having been superimposed on an image having been displayed before the change in a case in which the monitoring area changes.

According to this aspect of the invention, in the case in which the drawing has been performed using a pointing object on the image displayed, when the image to be displayed is changed, it is possible to erase the drawing not corresponding to the image having changed.

### BRIEF DESCRIPTION OF THE DRAWINGS

The invention will be described with reference to the accompanying drawings, wherein like numbers reference like elements.

FIG. 1 is a diagram showing devices constituting a display system 1.

FIG. 2 is a diagram showing a hardware configuration of a projector 10 and a pointing element 20.

FIG. 3 is a functional block diagram of a control section 110 and a control section 210.

FIG. 4 is a diagram showing an example of a time chart of detecting the pointing element.

FIG. 5 is a diagram showing an example of a page projected on a screen SC.

FIG. 6 is a diagram for explaining a monitoring area.

FIG. 7 is a flowchart showing a flow of a process executed by the control section 110.

FIG. 8 is a diagram showing an example of an image projected on the screen SC.

FIG. 9 is a flowchart showing a flow of a change process.

FIGS. 10A and 10B are diagrams showing an example of a data list.

FIG. 11 is a diagram showing an example of an image projected on the screen SC.

FIG. 12 is a diagram showing an example of an image projected on the screen SC.

### DESCRIPTION OF AN EXEMPLARY EMBODIMENT

### Embodiment

### Configuration of Embodiment

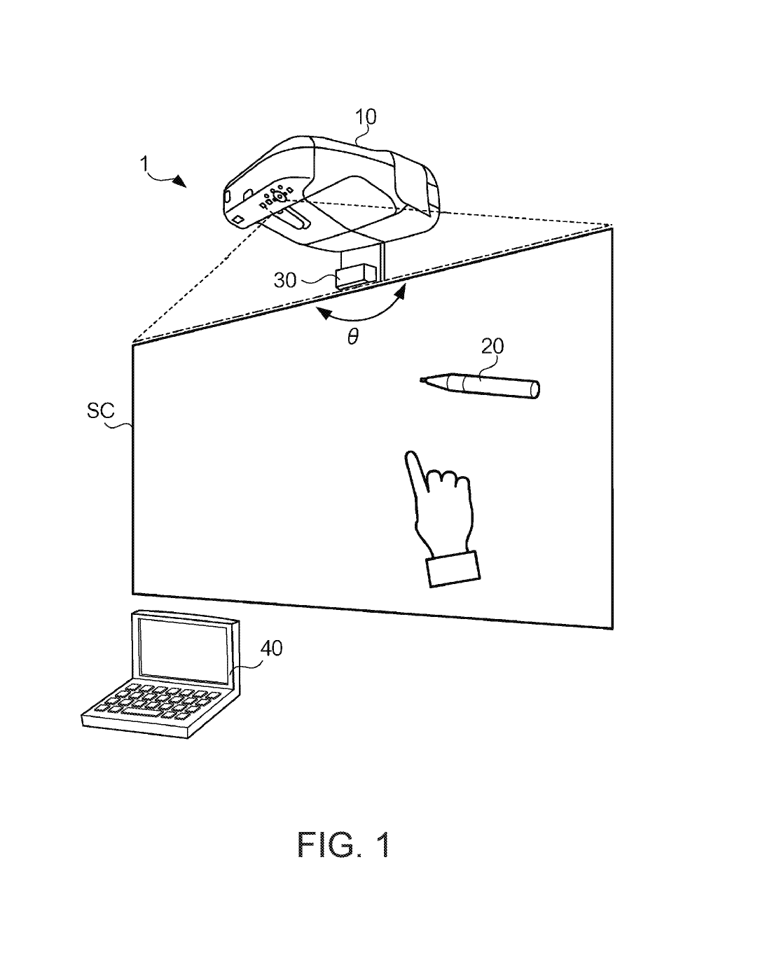

FIG. 1 is a diagram showing devices constituting a display system 1 according to an embodiment of the invention. The display system 1 is provided with a projector 10 for projecting an image on a screen SC to be a display surface of the image, a pointing element 20, and a light emitting device 30.

The projector 10 as an example of a display device is connected to a personal computer (PC) 40 as an example of an external device, and projects an image represented by a video signal, which is supplied from the PC 40, on the screen SC. Further, the projector 10 is provided with a drawing function of drawing an image at the position pointed by the pointing element 20 or a finger, and a PC operation function of using the pointing element 20 or the finger as a pointing device of the PC connected to the projector 10.

The projector 10 according to the present embodiment is installed obliquely above the screen SC, and projects an image toward the screen SC. Although in the present embodiment, the projector 10 projects the image toward the screen SC, it is also possible to project the image on a wall surface (the display surface) instead of the screen SC. Further, in the present embodiment, the projector 10 has a configuration of being installed on the wall surface with a bracket, but can also be installed on the ceiling.

The pointing element 20 shaped like a pen functions as a pointing device in the case of using the drawing function or the PC operation function described above, and is used in the case in which the user operates the graphical user interface (GUI) of the PC projected by the projector 10, the case in which the user performs drawing over the image projected in an overlapping manner, and so on.

The light emitting device 30 has a light emitting section for irradiating a finger located on the screen SC with light (infrared light in the present embodiment). The light emitting device 30 is disposed above an upper end of the screen SC, and emits the light dispersed in a range of an angle θ downward. The light emitted from the light emitting device 30 forms a layer of light extending along the screen SC. In the present embodiment, the angle θ reaches about 180 degrees, and thus, the layer of light is formed on roughly the entire area of the screen SC. It is preferable for the surface of the screen SC and the layer of light formed by the light emitting device 30 to be adjacent to each other. The layer of light is made to be thick so that a finger located at a position distant from the surface of the screen SC can also be irradiated. Further, it is also possible to stack the layers of the light emitting section to thereby irradiate the finger located at a distant position. The projector 10 controls emission of the light from the light emitting device 30.

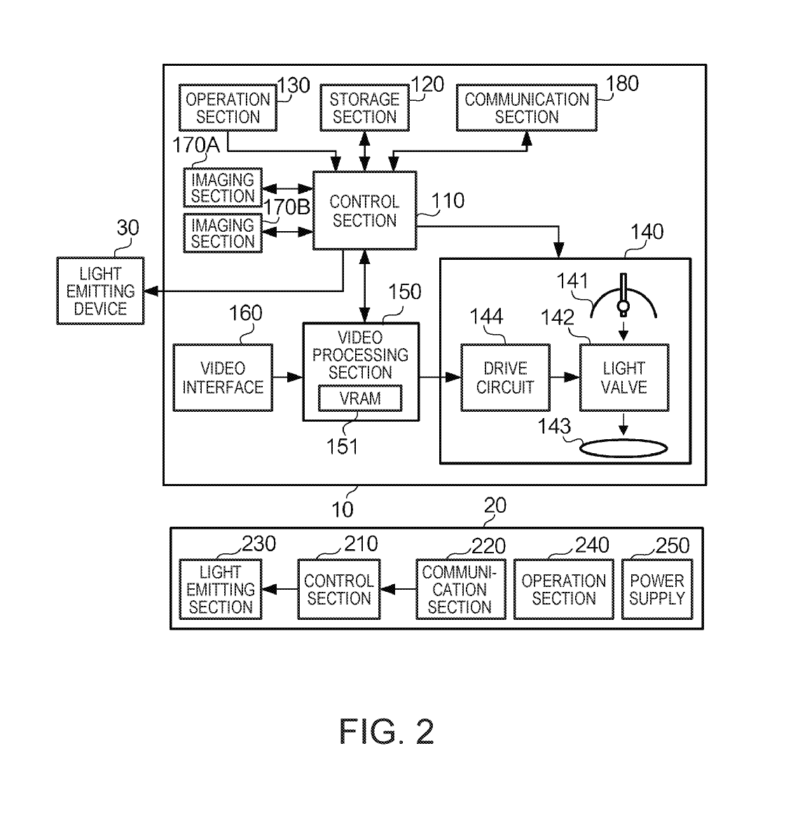

FIG. 2 is a diagram showing a hardware configuration of the projector 10 and the pointing element 20. The pointing element 20 has a control section 210, a communication section 220, a light emitting section 230, an operation section 240, and a power supply 250. The power supply 250 is, for example, a dry battery or a secondary cell, and supplies the control section 210, the communication section 220, the light emitting section 230, and the operation section 240 with electric power. The operation section 240 is provided with a switch (not shown) for controlling the supply of the electric power from the power supply 250 to each of the sections. When the switch of the operation section 240 is set to the ON state, the electric power is supplied from the power supply 250 to each of the sections, and when the switch of the operation section 240 is set to the OFF state, the supply of the electric power from the power supply 250 to each of the sections is stopped. The light emitting section 230 has a light emitting diode for emitting infrared light, and is disposed on the tip of the pointing element 20. The control section 210 controls lighting and extinction of the light emitting section 230. The light emitting section 230 is a point light source, and the light emitted by the light emitting section 230 spreads from the tip of the pointing element 20 in a spherical manner. The communication section 220 is provided with a light receiving element for receiving the infrared light. The communication section 220 receives a variety of signals transmitted from the projector 10 with the infrared light. The communication section 220 converts the variety of signals thus received into electric signals, and then supplies the control section 210 with the electric signals. The control section 210 is connected to the light emitting section 230 and the communication section 220. The control section 210 starts the control of the light emitting section 230 in accordance with the signal supplied from the communication section 220 to control lighting and extinction of the light emitting diode of the light emitting section 230.

The projector 10 is provided with a control section 110, a storage section 120, an operation section 130, and a projection section 140. Further, the projector 10 is provided with a video processing section 150, a video interface 160, an imaging section 170A, an imaging section 170B, and a communication section 180. The control section 110 is a microcomputer provided with a central processing unit (CPU), a read only memory (ROM), and a random access memory (RAM). When the CPU executes a program stored in the ROM, the control section 110 controls each of the sections to realize a function of projecting an image on the screen SC, a function of using a finger and the pointing element 20 as the pointing device, a drawing function, a PC operation function, and so on in the projector 10.

The video interface 160 has a plurality of connectors supplied with video signals such as RCA, D-sub, HDMI (registered trademark), or USB (universal serial bus), and supplies the video processing section 150 with the video signals, which have been supplied from the external device to the connectors. The video interface 160 is an example of a video acquisition unit for obtaining a plurality of video signals. It is also possible for the video interface 160 to have an interface for wireless communication such as wireless LAN or Bluetooth (registered trademark) to obtain the video signals with the wireless communication.

The storage section 120 stores a preset value related to the image quality of the picture to be projected, and information related to a variety of functions. The operation section 130 is provided with a plurality of buttons for operating the projector 10. By the control section 110 controlling each of the sections in accordance with the buttons having been operated, there are performed an adjustment of the image to be projected on the screen SC, setting of a variety of functions provided to the projector 10, and so on. Further, the operation section 130 is provided with a light receiving section (not shown) for receiving an infrared signal from a remote controller (not shown). The operation section 130 converts the signal transmitted from the remote controller into an electric signal to supply the result to the control section 110, and then the control section 110 controls each section in accordance with the signal supplied.

The projection section 140 and the video processing section 150 function as a display section for displaying an image in cooperation with each other. The video processing section 150 obtains the video signals supplied from the video interface 160. Further, the video processing section 150 obtains a signal of an on-screen image such as a GUI for operating the projector 10, a cursor indicating a position pointed by the pointing element 20, and an image drawn with the drawing function from the control section 110. The video processing section 150 is provided with a video RAM (VRAM) 151, and is provided with an area for developing the video signal and an area for developing the signal of the on-screen image, and develops the signals in the respective areas. The video processing section 150 is provided with a variety of image processing functions, and performs image processing on the video signal developed in the VRAM 151 to control the image quality of the image to be projected. Further, in the case in which the video processing section 150 is supplied with the signal of the on-screen image from the control section 110, the video processing section 150 supplies the projection section 140 with the video signal on which the signal of the on-screen image is superimposed. In other words, the video processing section 150 functions as a superimposition section for superimposing the on-screen image on the image (an external device image) of the video signal supplied from the external device.

The projection section 140 for projecting the picture includes alight source 141, alight valve 142, a drive circuit 144, and a projection optical system 143. The light source 141 is a lamp for emitting light, and the light emitted by the light source 141 is dispersed by a plurality of dichroic mirrors and mirrors not shown into light beams of red, green, and blue, and the light beams of red, green, and blue obtained by the dispersion are guided to the light valve 142. It should be noted that the light source 141 can also be a light emitting diode, or a semiconductor laser device for emitting a laser beam instead of the lamp.

The drive circuit 144 obtains the video signal supplied from the video processing section 150. The video signal supplied to the drive circuit 144 includes grayscale data representing a grayscale of a red component in the image to be projected, grayscale data representing a grayscale of a green component in the image to be projected, and grayscale data representing a grayscale of a blue component in the image to be projected. The drive circuit 144 extracts the grayscale data of each of the colors of red, green, and blue to drive the light valve 142 based on the grayscale data of each of the colors thus extracted.

The light valve 142 includes a liquid crystal light valve to which the red light beam described above is input, a liquid crystal light valve to which the green light beam described above is input, and a liquid crystal light valve to which the blue light beam described above is input. The liquid crystal light valves are each a transmissive liquid crystal panel, and are each provided with pixels arranged in a matrix with a plurality of rows and a plurality of columns. The liquid crystal light valve to which the red light beam is input is driven based on the red grayscale data, the liquid crystal light valve to which the green light beam is input is driven based on the green grayscale data, and the liquid crystal light valve to which the blue light beam is input is driven based on the blue grayscale data. In each of the liquid crystal light valves, the drive circuit 144 controls each of the pixels to vary the transmittance of the pixel. By controlling the transmittance of the pixels, the light beams of the respective colors having been transmitted through the respective liquid crystal light valves turn to the images corresponding to the respective grayscale data. The images of the light beams of red, green, and blue having been transmitted through the respective liquid crystal light valves are combined with each other by a dichroic prism not shown, and then enter the projection optical system 143. The projection optical system 143 is an optical system for enlarging the image having entered the projection optical system 143, and projects the image having entered the projection optical system 143 on the screen SC in an enlarged manner using a lens or a mirror. When the image is projected on the screen SC, the image is displayed on the screen SC as the display surface. It should be noted that it is also possible to adopt reflective liquid crystal panels instead of the transmissive liquid crystal panels, and it does not matter that a digital mirror device or the like is used.

The projector 10 has two imaging sections, namely the imaging section 170A and the imaging section 170B, in order to identify the position of the pointing element 20 or the finger, and the distance to the screen SC using a stereo method. The imaging section 170A and the imaging section 170B are each provided with an imaging element (e.g., CMOS or CCD) for receiving the infrared light emitted by the light emitting section 230 and the infrared light, which has been emitted from the light emitting device 30 and then reflected by the finger, an optical system for forming an image on the imaging element, an aperture for limiting the light entering the imaging element, and so on. The imaging section 170A and the imaging section 170B each have an imaging range including the screen SC, generate an image of the range thus imaged, and then output an image signal representing the image thus generated. It should be noted that in the present embodiment, since the projector 10 is installed obliquely above the screen SC, it results that the imaging section 170A and the imaging section 170B image the range including the screen SC from obliquely above. The communication section 180 is provided with a light emitting diode for emitting infrared light. The communication section 180 is controlled by the control section 110 in lighting and extinction of the light emitting diode, and transmits an infrared signal for controlling lighting and extinction of the light emitting section 230. Further, the communication section 180 has a communication interface for perform communication with the PC, and is provided with, for example, the communication interface compatible with USB or LAN.

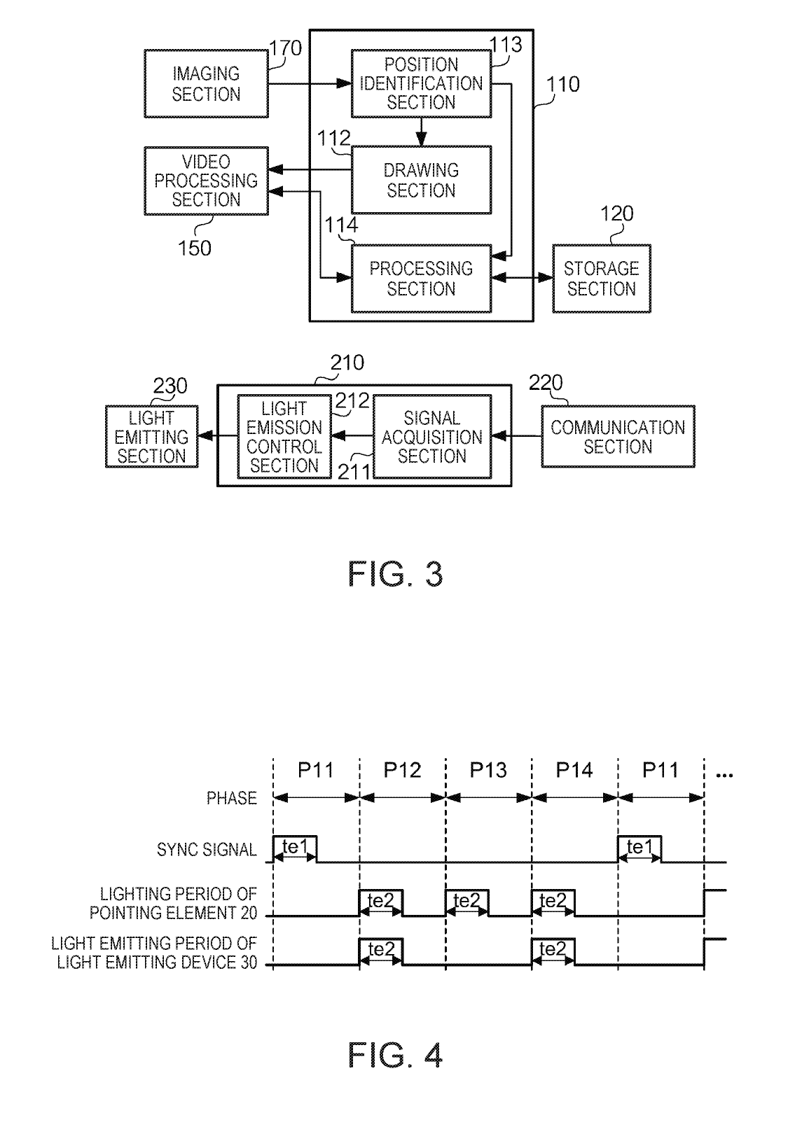

FIG. 3 is a functional block diagram showing a configuration of the functions realized by the control section 110 executing programs, and the functions realized by the control section 210. Firstly, there will be described the functions realized by the control section 110 of the projector 10.

A position identification section 113 periodically identifies the position of the light emitting section 230 of the pointing element 20 and the position of the finger as an example of the pointing element in the projection area of the image with, for example, the time chart shown in FIG. 4. The period for identifying the position of the finger or the position of the light emitting section 230 includes four phases, namely a phase P11 through a phase P14 as shown in FIG. 4. When detecting the position of the finger or the position of the light emitting section 230, the phases P11 through P14 are repeated. The phase P11 is a phase for synchronizing the timing, at which the projector 10 performs imaging with the imaging section 170A and the imaging section 170B, with the timing, at which the pointing element 20 emits light, and the timing, at which the light emitting device 30 emits the infrared light, with each other. In the phase P11, the position identification section 113 controls the communication section 180 so that a sync signal of the infrared light is output in a predetermined period te1.

In the pointing element 20, the communication section 220 receives the light of the sync signal, and when a predetermined time has elapsed after receiving the sync signal, the control section 210 controls the light emitting section 230 so that the light emitting section 230 lights in a period te2 set in advance. In the present embodiment, the light emitting section 230 is controlled so as to light from a starting point of each of the phases P12, P13, and P14. Further, the position identification section 113 controls the light emitting device 30 so that the light emitting device 30 emits the infrared light in the period te2 from the starting point of each of the phase P12 and the phase P14.

In the phases P12 through P14, the position identification section 113 controls the imaging section 170A and the imaging section 170B to image a predetermined range including the screen SC at a preset shutter speed. In each of the imaging section 170A and the imaging section 170B, an exposure period, in which the exposure is performed using the electronic shutter function, begins at the starting point of each of the phases P12 and P14, and the point at which the exposure ends is determined in accordance with the preset shutter speed. The image signal of the image taken by each of the imaging section 170A and the imaging section 170B in the exposure period of each of the phases P12 through P14 is supplied to the position identification section 113.

The position identification section 113 identifies the position of the finger or the light emitting section 230 located on the image projected, and the distance from the screen SC to the light emitting section 230 using the images represented by the image signals supplied from the imaging section 170A and the imaging section 170B. Specifically, in the phase P12 and the phase P14, in the case in which the finger is irradiated with the infrared light emitted by the light emitting device 30, the infrared light, which has been emitted from the light emitting device 30 and then reflected by the finger, is reflected in the images obtained by the imaging section 170A and the imaging section 170B. Further, in the phase P12 and the phase P14, if the light emitting section 230 is located in the imaging range of the imaging section 170A and the imaging section 170B, the infrared light emitted by the light emitting section 230 is also reflected in the images obtained by the imaging section 170A and the imaging section 170B. In the phase P13, since the light emitting device 30 does not emit the light, the infrared light emitted by the light emitting section 230 is reflected in the images obtained by the imaging section 170A and the imaging section 170B.

The position identification section 113 identifies the position and the distance to the screen SC of the infrared light reflected in the images obtained by the imaging section 170A and the imaging section 170B using the stereo method in the phases P12 through P14. The position identification section 113 identifies the infrared light located at the position close to the position of the infrared light, the position of which has been identified in the phase P13, out of the infrared light, the positions of which have been identified in the phases P12 and P14, and then determines the position of the infrared light thus identified as the position of the light emitting section 230. Further, the position identification section 113 determines the position of the infrared light far from the infrared light, the position of which has been identified in the phase P13, out of the infrared light, the positions of which have been identified in the phases P12 and P14, as the position of the finger. It should be noted that in the case in which the infrared light does not exist in the imaging range in the phase P13, the position identification section 113 determines the position identified in the phases P12 and P14 as the position of the finger. These positions identified are used when performing the variety of functions such as the drawing function or the PC operation function.

A drawing section 112 performs drawing on the image presently projected in accordance with the position detected by the position identification section 113.

A processing section 114 sets a part of the image to be projected as a monitoring area in accordance with the position identified by the position identification section 113. Further, the processing section 114 controls storage and display of an image, which has been drawn by the pointing element 20 or the finger, in accordance with the change in the image in the monitoring area.

Then, the functions realized by the control section 210 of the pointing element 20 will be described. A signal acquisition section 211 obtains a sync signal received by the communication section 220. A light emission control section 212 obtains the sync signal from the signal acquisition section 211, and then controls the light emitting section 230 so that the light emitting section 230 lights in the period te2 in each of the phases P12 through P14 when a predetermined time elapses after the sync signal is obtained.

### Operation Example of Embodiment

Then, an operation example of the present embodiment in the case in which the drawing function is set to the ON state will be described. Firstly, the user opens a file of a document such as a handout for a presentation having a page number in the PC 40 connected to the projector 10. When the PC 40 displays one page of the document, the video signal of the page thus displayed is supplied from the PC 40 to the projector 10. The video interface 160 obtains the video signal supplied from the PC 40, and then supplies the video signal thus obtained to the video processing section 150.

In the case in which the drawing function is in the ON state, the control section 110 supplies the video processing section 150 with a signal of an on-screen image of a button for switching between ON and OFF of a drawing recording function for associating the image drawn by the pointing element 20 or the finger and the image currently projected with each other. The video processing section 150 develops the signal thus supplied in the VRAM 151, and then supplies the projection section 140 with the video signal on which the imaging process has been performed in the VRAM 151. The projection section 140 projects the image represented by the video signal thus supplied on the screen SC.

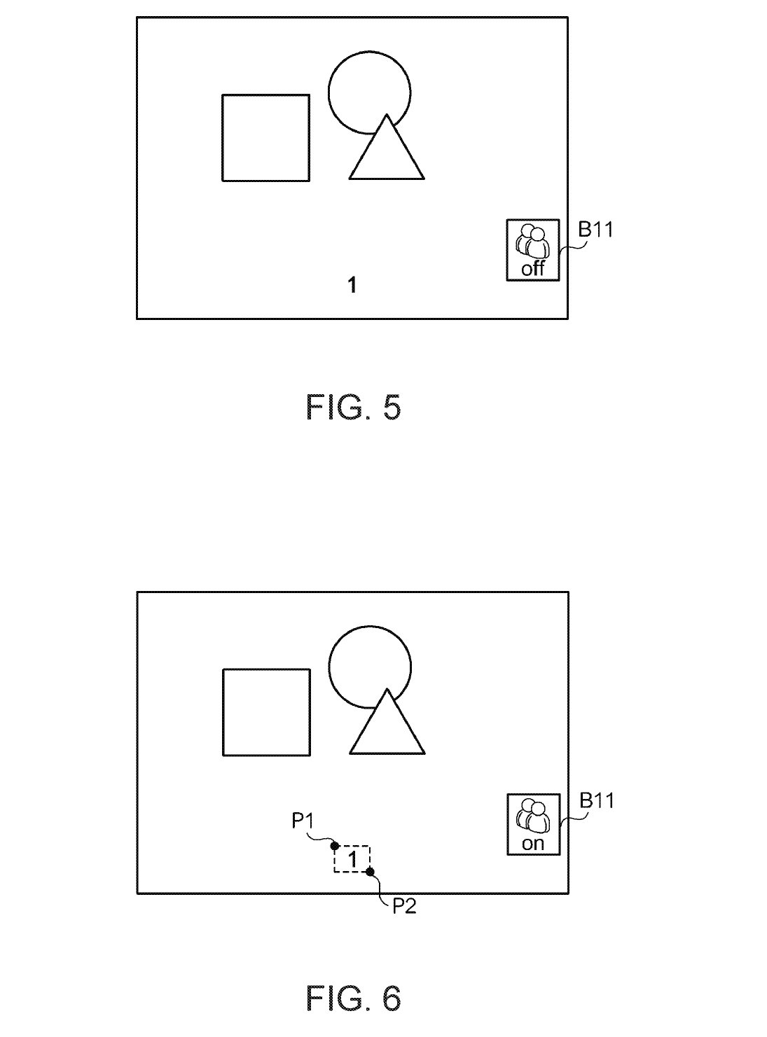

FIG. 5 is a diagram showing an example of the page projected on the screen SC. When the projection section 140 projects the image on the screen SC, the page displayed in the PC 40, and the button B11 for switching between ON and OFF of the drawing recording function are projected on the screen SC. In the case of associating the drawing performed by the pointing element 20 or the finger with the picture presently projected, the user moves the pointing element 20 to the position of the button B11. When the pointing element 20 is located on the screen SC, the control section 110 identifies the position of the pointing element 20. In the case in which the drawing function is in the ON state, the drawing recording function is in the OFF state, and the position identified is the position of the button B11, the control section 110 sets the drawing recording function to the ON state.

When the control section 110 sets the drawing recording function to the ON state, the control section 110 gets to the state of setting apart of the image to be projected as the monitoring area. Here, when the user moves the tip of the pointing element 20 from the position P1 to the position P2 shown in FIG. 6, the control section 110 (the position identification section 113) analyzes the video signals supplied from the imaging section 170A and the imaging section 170B to identify the position of the pointing element 20. The control section 110 (the processing section 114) sets a rectangular area (a rectangular area indicated by a dotted line in FIG. 6), which has a line connecting the position P1 and the position P2 as the diagonal line, and includes the page number, as the monitoring area.

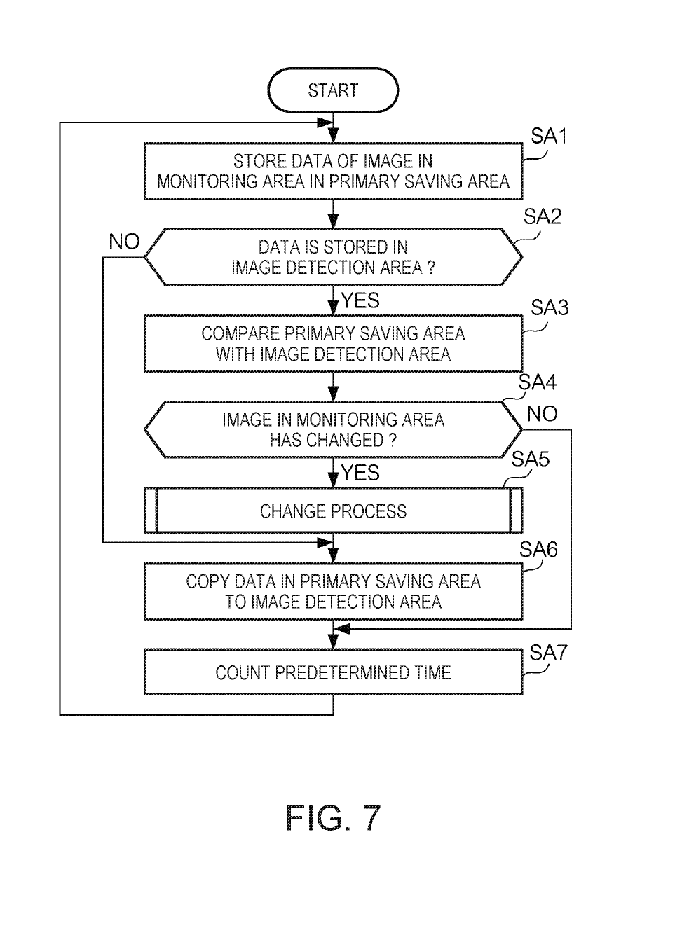

FIG. 7 is a flowchart showing a flow of a process executed by the control section 110 (the processing section 114) after setting the monitoring area. The control section 110 copies the data of the image in the monitoring area thus set, and then stores (step SA1) the data in a primary saving area provided to the VRAM 151. It should be noted that the data of the image to be stored in the primary saving area is the data of the image based on the video signal supplied from the PC 40 (the external device). It should be noted that the data of the image to be stored in the primary saving area can also be the data of the image based on the video signal in which the on-screen image such as an image drawn with the drawing function is superimposed on the image based on the video signal supplied from the PC 40 (the external device). Here, the data to be stored in the primary saving area of the VRAM 151 is the data of the image of “1” as the page number.

Then, the control section 110 determines (step SA2) whether or not any data is stored in an image detection area provided to the VRAM 151. The control section 110 initializes the image detection area when the monitoring area is set, and therefore, no data is stored in the image detection area in this case, and the control section 110 determines NO in the step SA2. If the control section 110 determines NO in the step SA2, the control section 110 makes the transition of the flow of the process to the step SA6 to copy (step SA6) the data in the primary saving area to the image detection area. Thus, the data of the image of “1” as the page number is stored in the image detection area. Then, the control section 110 counts (step SA7) predetermined time, and then makes the transition of the flow of the process to the step SA1. In the present embodiment, the time counted in the step SA7 is 0.5 second, but it is also possible to count the time shorter than 0.5 second or the time longer than 0.5 second.

The control section 110 makes the transition of the flow of the process to the step SA1, and then copies the data of the image in the monitoring area thus set to store the data in the primary saving area. After the control section 110 performs the process in the step SA6, the data is stored in the image detection area, and therefore, the control section 110 determines YES in the step SA2 in this case.

Then, the control section 110 compares (step SA3) the data stored in the image detection area and the data stored in the primary saving area to each other to determine (step SA4) whether or not the image in the monitoring area has changed. In the case in which the data stored in the image detection area and the data stored in the primary saving area are the same as each other, the control section 110 determines (ON in the step SA4) that the image in the monitoring area in the image presently projected has not changed, and then makes the transition of the flow of the process to the step SA7. During the period in which the image in the monitoring area does not change, the control section 110 repeats the process in the step SA1, the step SA2, the step SA3, the step SA4, and the step SA7.

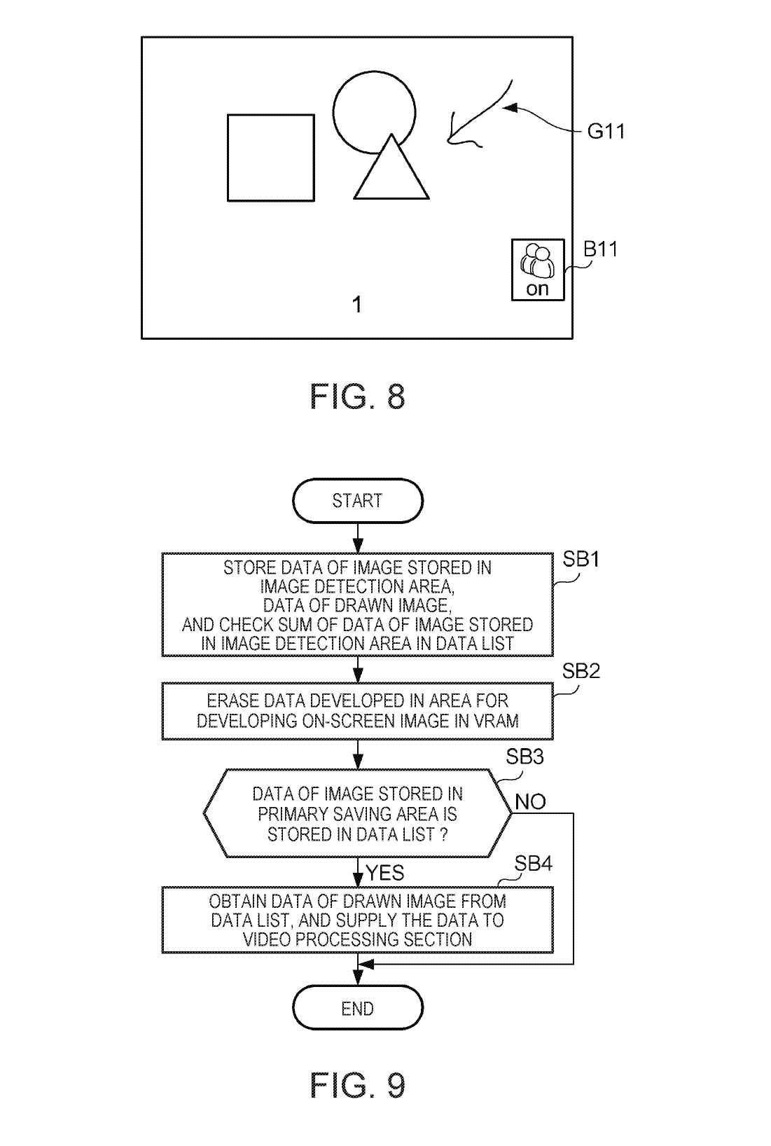

Subsequently, when the user moves the pointing element 20 on the screen SC in the state in which the image of the first page shown in FIG. 5 is displayed, the control section 110 (the position identification section 113) analyzes the video signals supplied from the imaging section 170A and the imaging section 170B to identify the position of the pointing element 20. The control section 110 (the drawing section 112) supplies the video processing section 150 with the signal of the on-screen image (an example of the drawn image) of a line connecting the positions identified. The video processing section 150 develops the signal of the on-screen image in the area for developing the signal of the on-screen image in the VRAM 151, and then supplies the projection section 140 with the video signal in which the on-screen image is superimposed on the image of the screen of the PC 40. When the projection section 140 projects the image of the video signal thus supplied, the image G11 corresponding to the movement of the pointing element 20 is projected as shown in FIG. 8, for example.

Then, when the user operates the PC 40 to perform an operation of turning the page of the document opened forward to the second page, the video signal of the second page of the document is supplied from the PC 40 to the projector 10. The video processing section 150 develops the video signal thus supplied in the VRAM 151. After the new video signal is developed in the VRAM, when the transition of the flow of the process to the step SA1 is made, the control section 110 copies the data of the image in the monitoring area, and then stores (step SA1) the data in the primary saving area. Thus, the data to be stored in the primary saving area is changed from the data of the image of “1” to the data of the image of “2.”

Then, the control section 110 determines (step SA2) whether or not any data is stored in the image detection area. At this moment, since the data of the image of “1” is stored in the image detection area, the control section 110 determines YES in the step SA2. The control section 110 determines YES in the step SA2, and then compares (step SA3) the data stored in the image detection area and the data stored in the primary saving area to each other to determine (step SA4) whether or not the image in the monitoring area has changed.

Here, since the image data of “2” as the page number is stored in the primary saving area, and the image data of “1” as the page number is stored in the image detection area, the control section 110 determines (YES in the step SA4) that the image in the monitoring area has changed. The control section 110 determines YES in the step SA4, and then performs (step SA5) a change process.

FIG. 9 is a flowchart showing a flow of the change process. Firstly, the control section 110 stores (step SB1) the data (the data of the image of “1” as the page number) of the image stored in the image detection area, the data (the data of the image G11 developed in the area for developing the on-screen image in the VRAM 151) of the image drawn using the pointing element 20, and the check sum (the check sum of the data of the image of “1” as the page number) of the data of the image stored in the image detection area in a data list so as to be associated with each other.

The data list is a list for storing the data of the image drawn using the pointing element 20, the data of the image in the monitoring area when the image is drawn with the pointing element 20, and the check sum of the data of the image in the monitoring area when the image is drawn with the pointing element 20 so as to be associated with each other.

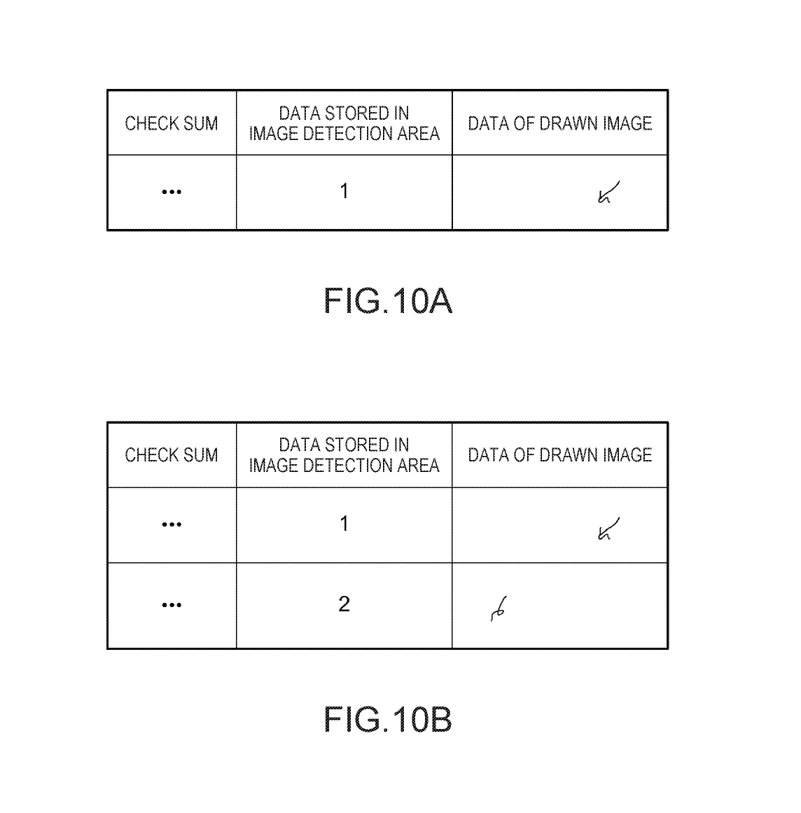

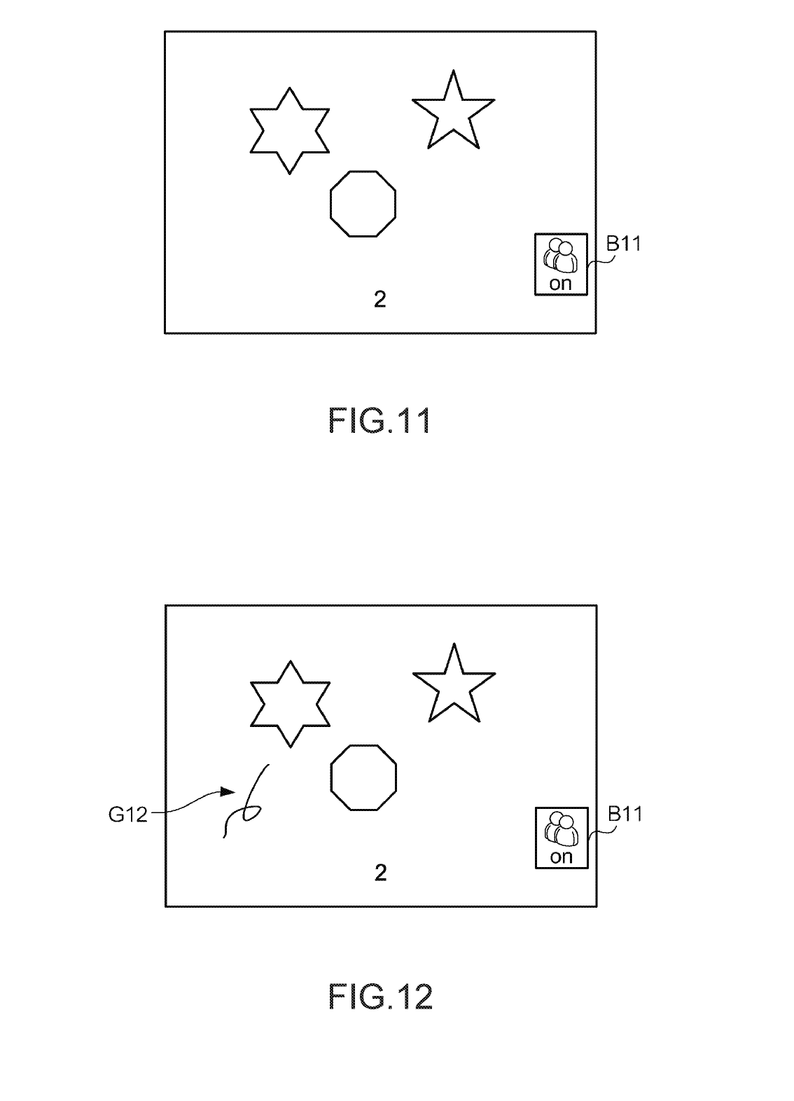

FIGS. 10A and 10B are diagrams showing an example of the data list. Here, the content of the data list is in the state shown in FIG. 10A. When the control section 110 completes the process in the step SB1, the control section 110 erases (step SB2) the data developed in the area for developing the on-screen image in the VRAM 151. When the process in the step SB2 is performed, the image to be superimposed on the image of the PC 40 no longer exists, and therefore, the image G11 having been projected is no longer displayed, and only the image of the second page displayed in the PC 40 is projected on the screen SC as shown in FIG. 11.

Then, the control section 110 determines (step SB3) whether or not the data of the image stored in the primary saving area is stored in the data list. The control section 110 obtains the check sum of the data of the image of “2” stored in the primary saving area, and then determines whether or not the check sum having the same value as that of the check sum thus obtained is stored in the data list.

In the state shown in FIG. 10A, although the check sum of the image of “1” as the page number is stored in the data list, the check sum having the same value as that of the check sum of the data of the image of “2” in the primary saving area is not stored in the data list. Therefore, the control section 110 determines (NO in the step SB3) that the data of the image stored in the primary saving area is not stored in the data list.

If the control section 110 determines NO in the step SB3, the control section 110 terminates the change process to return the flow of the process to the step SA6 to copy (step SA6) the data in the primary saving area to the image detection area. Here, the data of the image of “2” as the page number currently projected is stored in the image detection area. Then, the control section 110 counts (step SA7) the predetermined time, and then makes the transition of the flow of the process to the step SA1.

Subsequently, when the user moves the pointing element 20 on the screen SC in the state in which the image of the second page is projected, the control section 110 analyzes the video signals supplied from the imaging section 170A and the imaging section 170B to identify the position of the pointing element 20, and then supplies the video processing section 150 with the signal of the on-screen image of the line connecting the positions identified. The video processing section 150 develops the signal of the on-screen image in the area for developing the on-screen image in the VRAM 151, and then supplies the projection section 140 with the video signal in which the on-screen image is superimposed on the image of the screen of the PC 40. When the projection section 140 projects the image of the video signal thus supplied, the image G12 corresponding to the movement of the pointing element 20 is projected as shown in FIG. 12.

Then, when the user operates the PC 40 to perform an operation of turning the page of the document opened backward from the second page to the first page, the video signal of the first page is supplied from the PC 40 to the projector 10. The video processing section 150 develops the video signal thus supplied in the VRAM 151. After the new video signal is developed in the VRAM, when the transition of the flow of the process to the step SA1 is made, the control section 110 copies the data of the image in the monitoring area, and then stores (step SA1) the data in the primary saving area. Thus, the data to be stored in the primary saving area is changed from the data of the image of “2” to the data of the image of “1.”

Then, the control section 110 determines (step SA2) whether or not any data is stored in the image detection area. At this moment, since the data of the image of “2” is stored in the image detection area, the control section 110 determines YES in the step SA2. The control section 110 determines YES in the step SA2, and then compares (step SA3) the data stored in the image detection area and the data stored in the primary saving area to each other to determine (step SA4) whether or not the image in the monitoring area has changed.

Here, since the image data of “1” as the page number is stored in the primary saving area, and the image data of “2” as the page number is stored in the image detection area, the control section 110 determines (YES in the step SA4) that the image in the monitoring area has changed. The control section 110 determines YES in the step SA4, and then performs (step SA5) the change process.

Here, the control section 110 stores (step SB1) the data (the data of the image of “2” as the page number) of the image stored in the image detection area, the data (the data of the image G12 developed in the area for developing the on-screen image in the VRAM 151) of the image drawn using the pointing element 20, and the check sum (the check sum of the data of the image of “2” as the page number) of the data of the image stored in the image detection area in a data list so as to be associated with each other. Here, the content of the data list is in the state shown in FIG. 10B. When the control section 110 completes the process in the step SB1, the control section 110 erases (step SB2) the data developed in the area for developing the on-screen image in the VRAM 151.

Then, the control section 110 determines (step SB3) whether or not the data of the image stored in the primary saving area is stored in the data list. The control section 110 obtains the check sum of the data of the image of “1” stored in the primary saving area, and then determines whether or not the check sum having the same value as that of the check sum thus obtained is stored in the data list.

In the state shown in FIG. 10B, since the check sum of the image of “1” as the page number is stored in the data list, the control section 110 determines (YES in the step SB3) that the data of the image stored in the primary saving area is stored in the data list. It should be noted that in the case in which a plurality of check sums equal to each other is stored in the data list, the control section 110 determines whether or not the data of the same image as the image in the primary saving area is stored in the data list by calculating an EXCUSIVE-OR of the data using the data of the image of the page number stored in the data list, and in the case in which the data of the same image is stored in the data list, the control section 110 determines YES in the step SB3.

If the control section 110 determines YES in the step SB3, the control section 110 obtains the data of the drawn image, which is stored so as to be associated with the check sum having the same value as that of the check sum of the data of the image in the primary saving area, and then supplies (step SB4) the image processing section 150 with the signal of the on-screen image as the image represented by the data thus obtained. Here, the control section 110 obtains the data of the image G11, and then supplies the video processing section 150 with the signal of the on-screen image of the image G11 represented by the data obtained.

The video processing section 150 develops the signal of the on-screen image in the area for developing the on-screen image in the VRAM 151, and then supplies the projection section 140 with the video signal in which the on-screen image is superimposed on the image of the screen of the PC 40. When the projection section 140 projects the image of the video signal supplied, the image of the first page of the document opened in the PC 40, and the image G11 drawn with the pointing element 20 when the image of the first page is projected are projected as shown in FIG. 8, for example.

The control section 110 completes the process in the step SB4, and then terminates the change process to return the flow of the process to the step SA6 to copy (step SA6) the data in the primary saving area to the image detection area. Here, the data of the image of “1” as the page number currently projected is stored in the image detection area. Then, the control section 110 counts (step SA7) the predetermined time, and then makes the transition of the flow of the process to the step SA1.

Then, when the user operates the PC 40 to perform an operation of turning the page of the document opened forward from the first page to the second page, the video signal of the second page is supplied from the PC 40 to the projector 10. The video processing section 150 develops the video signal thus supplied in the VRAM 151. After the new video signal is developed in the VRAM, when the transition of the flow of the process to the step SA1 is made, the control section 110 copies the data of the image in the monitoring area, and then stores (step SA1) the data in the primary saving area. Thus, the data to be stored in the primary saving area is changed from the data of the image of “1” to the data of the image of “2.”

Then, the control section 110 determines (step SA2) whether or not any data is stored in the image detection area. At this moment, since the data of the image of “1” is stored in the image detection area, the control section 110 determines YES in the step SA2. The control section 110 determines YES in the step SA2, and then compares (step SA3) the data stored in the image detection area and the data stored in the primary saving area to each other to determine (step SA4) whether or not the image in the monitoring area has changed.

Here, since the image data of “2” as the page number is stored in the primary saving area, and the image data of “1” as the page number is stored in the image detection area, the control section 110 determines (YES in the step SA4) that the image in the monitoring area has changed. The control section 110 determines YES in the step SA4, and then performs (step SA5) the change process.

The control section 110 stores (step SB1) the data (the data of the image of “1” as the page number) of the image stored in the image detection area, the data (the data of the image G11 developed in the area for developing the on-screen image in the VRAM 151) of the image drawn using the pointing element 20, and the check sum (the check sum of the data of the image of “1” as the page number) of the data of the image stored in the image detection area in the data list so as to be associated with each other. It should be noted that in the case in which the data of the same image and having the same check sum as those of the image stored in the image detection area has already been stored in the data list, the control section 110 updates the data of the image drawn using the pointing element 20. When the control section 110 completes the process in the step SB1, the control section 110 erases (step SB2) the data developed in the area for developing the on-screen image in the VRAM 151.

Then, the control section 110 determines (step SB3) whether or not the data of the image stored in the primary saving area is stored in the data list. The control section 110 obtains the check sum of the data of the image of “2” stored in the primary saving area, and then determines whether or not the check sum having the same value as that of the check sum thus obtained is stored in the data list.

In the state shown in FIG. 10B, since the check sum of the image of “2” as the page number is stored in the data list, the control section 110 determines (YES in the step SB3) that the data of the image stored in the primary saving area is stored in the data list.

If the control section 110 determines YES in the step SB3, the control section 110 obtains the data of the drawn image, which is stored so as to be associated with the check sum having the same value as that of the check sum of the data of the image in the primary saving area, and then supplies (step SB4) the image processing section 150 with the signal of the on-screen image as the image represented by the data thus obtained. Here, the control section 110 obtains the data of the image G12, and then supplies the video processing section 150 with the signal of the on-screen image of the image G12 represented by the data obtained.

The video processing section 150 develops the signal of the on-screen image in the area for developing the on-screen image in the VRAM 151, and then supplies the projection section 140 with the video signal in which the on-screen image is superimposed on the image of the screen of the PC 40. When the projection section 140 projects the image of the video signal supplied, the image of the second page of the document opened in the PC 40, and the image G12 drawn with the pointing element 20 when the image of the second page is projected are projected as shown in FIG. 12, for example.

As described hereinabove, according to the present embodiment, in the case in which the drawing has been performed using the pointing element on the image displayed, if the image to be displayed changes, it is possible to erase the drawing not corresponding to the image after the change, and to restore and display the drawing performed on the image displayed.

### MODIFIED EXAMPLES

Although the embodiment of the invention is described hereinabove, the invention is not limited to the embodiment described above, but can be implemented in other various forms. For example, the invention can be implemented by modifying the embodiment described above as follows. It should be noted that the embodiment described above and the following modified examples can be implemented alone or in arbitrary combination.

Although in the embodiment described above, whether or not the image in the monitoring area has changed is determined using the data of the image in the monitoring area, the configuration for determining whether or not the image in the monitoring area has changed is not limited to the configuration in the embodiment. For example, it is also possible to analyze the part corresponding to the monitoring area set in the images (the taken images) taken by the imaging section 170A and the imaging section 170B to determine whether or not the image in the monitoring area has changed.

In the embodiment described above, there is adopted the configuration in which the user sets the monitoring area, but the invention is not limited to this configuration. For example, it is possible to use a plurality of rows of pixels determined in advance as the monitoring area out of the pixels of the image represented by the video signal supplied. For example, an n-th line, an n+α-th line, and an n+β-th line of the image represented by the video signal supplied can be used as the predetermined area. The plurality of rows is not limited to three rows, but can be two rows, or four or more rows.

Further, it is possible to use a plurality of columns of pixels determined in advance as the monitoring area out of the pixels of the image represented by the video signal supplied. Further, it is possible to use a plurality of rows of pixels and a plurality of columns of pixels determined in advance as the monitoring area out of the pixels of the image represented by the video signal supplied.

Although in the embodiment described above, the projector 10 projects the image represented by the video signal supplied from the PC 40, and the projector 10 generates and then projects the image drawn on the image projected, the invention is not limited to this configuration.

For example, a page including the page number is displayed in a touch panel of a tablet terminal, and drawing of an image is performed on the image displayed using a finger or a stylus pen. In this configuration, the user sets the monitoring area with the finger or the stylus pen, and the tablet terminal monitors the image in the monitoring area similarly to the embodiment described above. The tablet terminal stores the image drawn during a period in which the page is displayed, the image in the monitoring area, and the check sum of the image in the monitoring area in the data list so as to be associated with each other. When a operation of changing the page to be displayed is performed, the tablet terminal obtains the image drawn during the period in which the page after the change is displayed from the data list, and then display the drawn image superimposed on the image of the page after the change. According also to this configuration, in the case in which the drawing has been performed using the pointing element on the image displayed, if the image to be displayed changes, it is possible to erase the drawing not corresponding to the image after the change, and to restore and display the drawing performed on the image displayed.

Although in the embodiment described above, the part corresponding to the page number is set as the monitoring area, the monitoring area is not limited to the part corresponding to the page number. For example, it is also possible to set the scroll bar as an example of the GUI as the monitoring area, and to perform the storage of the data to the data list and the display of the drawn image in accordance with the change in position of the knob of the scroll bar. According to this configuration, if drawing is performed in the case in which the position of the knob is a first position, the image drawn is stored in the data list so as to be associated with the image of the scroll bar at this moment, for example. Further, if drawing is performed in the case in which the position of the knob is a second position, the image drawn is stored in the data list so as to be associated with the image of the scroll bar at this moment. Then, if the position of the knob changes from the second position to the first position, the image drawn while the knob is in the first position is obtained from the data list, and is then displayed, and if the position of the knob changes from the first position to the second position, the image drawn while the knob is in the second position is obtained from the data list, and is then displayed.

The programs realizing the functions related to the invention can be provided in the state of being stored in a computer readable recording medium such as a magnetic recording medium (e.g., a magnetic tape, a magnetic disk (e.g., a hard disk drive (HDD) or a flexible disk (FD)), an optical recording medium (e.g., an optical disk), a magneto-optical recording medium, or a semiconductor memory, and then installed in the respective devices. Further, it is also possible to download the programs via a communication network, and then install the programs in the respective devices.

The entire disclosure of Japanese Patent Application No. 2016-053451, filed Mar. 17, 2016 is expressly incorporated by reference herein.

What is claimed is:

1. A display device comprising:
a display section adapted to display an image on a display surface;
a position identification section adapted to identify a position of a pointing element to the display surface;
a drawing section adapted to generate a drawn image based on the position identified by the position identification section;
a superimposition section adapted to superimpose the drawn image on an external device image based on a video signal supplied from an external device to generate the image; and
a processing section adapted to detect a change in a monitoring area set in advance of generation of the drawn image in a display area of the image to be displayed by the display section, and adapted to erase the drawn image having been superimposed on an image having been displayed before the change in a case in which the monitoring area changes.

2. The display device according to claim 1, further comprising:
a storage section adapted to store an image displayed in the monitoring area, and the drawn image generated by the drawing section while the image is displayed so as to be associated with each other,
wherein the processing section supplies the superimposition section with the drawn image stored so as to be associated with the image displayed in the monitoring area.

3. The display device according to claim 1, wherein
the monitoring area is an area designated by an operation of the pointing element.

4. The display device according to claim 1, wherein
a number of the monitoring areas is plural.

5. The display device according to claim 4, wherein
the monitoring areas are areas extending in at least one predetermined direction in the image to be displayed on the display surface.

6. The display device according to claim 5, wherein
a number of the directions is plural.

7. The display device according to claim 1, wherein
the processing section detects a change of the external device image in the monitoring area.

8. The display device according to claim 1, further comprising:
an imaging section adapted to take the image displayed by the display section, and output a taken image obtained by imaging,
wherein the processing section detects a change of apart corresponding to the monitoring area in the taken image.

9. A method of controlling a display device including a display section adapted to display an image on a display surface, the method comprising:
identifying a position of a pointing element to the display surface;
generating a drawn image based on the position identified in the identifying the position of the pointing element;
superimposing the drawn image on an external device image based on a video signal supplied from an external device to generate the image; and
detecting a change in a monitoring area set in advance of generation of the drawn image in a display area of the image to be displayed by the display section, and erasing the drawn image having been superimposed on an image having been displayed before the change in a case in which the monitoring area changes.

10. A computer program adapted to make a computer of a display device including a display section adapted to display an image on a display surface execute a process comprising:
identifying a position of a pointing element to the display surface;
generating a drawn image based on the position identified in the identifying the position of the pointing element;
superimposing the drawn image on an external device image based on a video signal supplied from an external device to generate the image; and
detecting a change in a monitoring area set in advance of generation of the drawn image in a display area of the image to be displayed by the display section, and erasing the drawn image having been superimposed on an image having been displayed before the change in a case in which the monitoring area changes.
